(19) United States
(12) Patent Application Publication
(10) Pub. No.: US 2026/0181671 A1
(43) Pub. Date: Jun. 25, 2026

(54) ADAPTABLE SLOT STRUCTURE FOR SIDELINK COMMUNICATIONS

(71) Applicant: QUALCOMM Incorporated, San Diego, CA (US)

(72) Inventors: Moshe BEN-ARI, Rehovot (IL); Ran BERLINER, Kfar-Aviv (IL); Tal OVED, Modiin (IL); Guy SPIEGELSTEIN, Nes-Ziona (IL)

(21) Appl. No.: 18/991,033

(22) Filed: Dec. 20, 2024

(51) Int. Cl. H04W 72/25; H04W 72/0446; H04W 72/0453

(52) U.S. Cl. CPC H04W 72/25; H04W 72/0446; H04W 72/0453

(57) ABSTRACT

Various aspects of the present disclosure generally relate to wireless communication. In some aspects, a transmitting user equipment (UE) may obtain a sidelink control message for transmission that at least partially overlaps in time with a time domain location of a first set of one or more time domain locations for communicating a data message reference signal according to a first configuration. The UE may transmit, in accordance with a second configuration, the sidelink control message during the time domain location and a set of data message reference signals during a second set of one or more other time domain locations in accordance with obtaining the sidelink control message. Numerous other aspects are described.

### FIELD OF THE DISCLOSURE

Aspects of the present disclosure generally relate to wireless communication and specifically relate to techniques, apparatuses, and methods associated with adaptable slot structure for sidelink communications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A demodulation reference signal (DMRS) may carry information used to estimate a radio channel for demodulation of an associated physical channel message. The design and mapping of a DMRS may be specific to a physical channel for which the DMRS is used for estimation. DMRSs may be used for downlink communications, uplink communications, and/or sidelink communications.

### SUMMARY

Some aspects described herein relate to an apparatus for wireless communication at a transmitting user equipment (UE). The apparatus may include one or more memories and one or more processors coupled to the one or more memories. The one or more processors may be configured to obtain a sidelink control message for transmission that at least partially overlaps in time with a time domain location of a first set of one or more time domain locations for communicating a data message reference signal according to a first configuration. The one or more processors may be configured to transmit, in accordance with a second configuration, the sidelink control message during the time domain location and a set of data message reference signals during a second set of one or more other time domain locations in accordance with obtaining the sidelink control message.

Some aspects described herein relate to an apparatus for wireless communication at a UE. The apparatus may include one or more memories and one or more processors coupled to the one or more memories. The one or more processors may be configured to obtain a sidelink control message for transmission via a first portion of a frequency allocation, wherein the sidelink control message at least partially overlaps in time with a time domain location for communicating a data message reference signal via a second portion of the frequency allocation according to a first configuration. The one or more processors may be configured to transmit, in accordance with a second configuration and via the first portion of the frequency allocation, a first set of data message reference signals in accordance with obtaining the sidelink control message. The one or more processors may be configured to transmit, according to the first configuration and via the second portion of the frequency allocation, a second set of data message reference signals including the data message reference signal.

Some aspects described herein relate to an apparatus for wireless communication at an UE. The apparatus may include one or more memories and one or more processors coupled to the one or more memories. The one or more processors may be configured to obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration. The one or more processors may be configured to transmit, via the first frequency subchannel, a set of data message reference signals according to a second resource configuration of a set of resource configurations in a data message reference signal configuration.

Some aspects described herein relate to a method of wireless communication performed by a transmitting UE. The method may include obtaining a sidelink control message for transmission that at least partially overlaps in time with a time domain location of a first set of one or more time domain locations for communicating a data message reference signal according to a first configuration. The method may include transmitting, in accordance with a second configuration, the sidelink control message during the time domain location and a set of data message reference signals during a second set of one or more other time domain locations in accordance with obtaining the sidelink control message.

Some aspects described herein relate to a method of wireless communication performed by a transmitting UE. The method may include obtaining a sidelink control message for transmission via a first portion of a frequency allocation, wherein the sidelink control message at least partially overlaps in time with a time domain location for communicating a data message reference signal via a second portion of the frequency allocation according to a first configuration. The method may include transmitting, in accordance with a second configuration and via the first portion of the frequency allocation, a first set of data message reference signals in accordance with obtaining the sidelink control message. The method may include transmitting, according to the first configuration and via the second portion of the frequency allocation, a second set of data message reference signals including the data message reference signal.

Some aspects described herein relate to a method of wireless communication performed by a transmitting UE. The method may include obtaining a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration. The method may include transmitting, via the first frequency subchannel, a set of data message reference signals according to a second resource configuration of a set of resource configurations in a data message reference signal configuration.

Some aspects described herein relate to a non-transitory computer-readable medium that stores a set of instructions for wireless communication by a transmitting UE. The set of instructions, when executed by one or more processors of the UE, may cause the UE to obtain a sidelink control message for transmission that at least partially overlaps in time with a time domain location of a first set of one or more time domain locations for communicating a data message reference signal according to a first configuration. The set of instructions, when executed by one or more processors of the UE, may cause the UE to transmit, in accordance with a second configuration, the sidelink control message during the time domain location and a set of data message reference signals during a second set of one or more other time domain locations in accordance with obtaining the sidelink control message.

Some aspects described herein relate to a non-transitory computer-readable medium that stores a set of instructions for wireless communication by a transmitting UE. The set of instructions, when executed by one or more processors of the UE, may cause the UE to obtain a sidelink control message for transmission via a first portion of a frequency allocation, wherein the sidelink control message at least partially overlaps in time with a time domain location for communicating a data message reference signal via a second portion of the frequency allocation according to a first configuration. The set of instructions, when executed by one or more processors of the UE, may cause the UE to transmit, in accordance with a second configuration and via the first portion of the frequency allocation, a first set of data message reference signals in accordance with obtaining the sidelink control message. The set of instructions, when executed by one or more processors of the one or more instructions that, when executed by one or more processors of an UE, may cause the one or more instructions that, when executed by one or more processors of an UE to transmit, according to the first configuration and via the second portion of the frequency allocation, a second set of data message reference signals including the data message reference signal.

Some aspects described herein relate to a non-transitory computer-readable medium that stores a set of instructions for wireless communication by a transmitting UE. The set of instructions, when executed by one or more processors of the UE, may cause the UE to obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration. The set of instructions, when executed by one or more processors of the UE, may cause the UE to transmit, via the first frequency subchannel, a set of data message reference signals according to a second resource configuration of a set of resource configurations in a data message reference signal configuration.

Some aspects described herein relate to an apparatus for wireless communication. The apparatus may include means for obtaining a sidelink control message for transmission that at least partially overlaps in time with a time domain location of a first set of one or more time domain locations for communicating a data message reference signal according to a first configuration. The apparatus may include means for transmitting, in accordance with a second configuration, the sidelink control message during the time domain location and a set of data message reference signals during a second set of one or more other time domain locations in accordance with obtaining the sidelink control message.

Some aspects described herein relate to an apparatus for wireless communication. The apparatus may include means for obtaining a sidelink control message for transmission via a first portion of a frequency allocation, wherein the sidelink control message at least partially overlaps in time with a time domain location for communicating a data message reference signal via a second portion of the frequency allocation according to a first configuration. The apparatus may include means for transmitting, in accordance with a second configuration and via the first portion of the frequency allocation, a first set of data message reference signals in accordance with obtaining the sidelink control message. The apparatus may include means for transmitting, according to the first configuration and via the second portion of the frequency allocation, a second set of data message reference signals including the data message reference signal.

Some aspects described herein relate to an apparatus for wireless communication. The apparatus may include means for obtaining a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration. The apparatus may include means for transmitting, via the first frequency subchannel, a set of data message reference signals according to a second resource configuration of a set of resource configurations in a data message reference signal configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram of an example associated with adaptable slot structure for sidelink communications, in accordance with the present disclosure.

FIG. 7A is a diagram illustrating an example associated with a slot structure for communicating sidelink control information and sidelink reference signals, in accordance with the present disclosure.

FIG. 7B is a diagram illustrating an example associated with a slot structure for communicating sidelink control information and sidelink reference signals, in accordance with the present disclosure.

FIG. 7C is a diagram illustrating an example associated with a slot structure for communicating sidelink control information and sidelink reference signals, in accordance with the present disclosure.

FIG. 7D is a diagram illustrating an example associated with a slot structure for communicating sidelink control information and sidelink reference signals, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented, or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE), such as a transmitting UE, may communicate with another UE, such as a receiving UE, by performing sidelink communications via time and/or frequency resources. For example, the time and/or frequency resources may be used to transmit reference signals including channel estimation information, control information, and/or sidelink data. In some examples, the structure of time resources for sidelink communications may be flexible (e.g., one slot format and/or structure may include a different pattern of messages than a preceding and/or subsequent slot). For example, a quantity of sidelink reference signal time resources (e.g., physical sidelink control channel (PSSCH) demodulation reference signals (DMRS) symbols) may vary according to a configuration of the UE. In some examples, the quantity of sidelink reference signal time resources may be 2, 3, or 4. A sidelink time resources structure may be flexible in order to balance UE mobility considerations with maintaining spectral efficiency. For example, the transmitting UE may adapt the quantity of reference signal time resources in a sidelink transmission according to channel conditions. For example, high mobility scenarios may be associated with lower quality channel conditions and thus, more reference signals may be useful for maintaining a baseline channel estimation quality. In other scenarios, the channel quality may be more stable, and thus fewer reference signals may be transmitted, and the UE may achieve a higher spectral throughput while maintaining channel estimation quality.

The transmitting UE may select the quantity of reference signal time resources according to, or otherwise based on, a reference signal pattern configuration (e.g., sl-PSSCH-DMRS-TimePatternList). A time domain location of each reference signal may be based on a reference signal location configuration (e.g., a PSSCH DMRS time domain location configuration table). In some aspects, the location of each reference signal time resource (e.g., PSSCH DMRS symbols) may be dictated by a quantity of sidelink data channel resources (e.g., PSSCH symbols), a quantity of sidelink control channel resources (e.g., physical sidelink control channel (PSCCH) symbols), and/or a quantity or reference signal resources (e.g., PSSCH DMRS symbols).

Some combinations of the reference signal pattern configuration and the reference signal location configuration may lead to scenarios in which demodulation by the receiving UE may degrade because the pattern of reference signals may be inefficiently spaced throughout the slot. For example: a space between reference signals may be relatively large, and thus time domain resources may occur without the receiving UE receiving up-to-date decoding (e.g., demodulating) information; a first occurring reference signal may not occur in a first occurring time resource of the slot and thus time domain resources may occur without the receiving UE receiving decoding (e.g., demodulating) information, among other examples. Such degradations may be more impactful when a sidelink control channel allocation size includes a single subchannel. In such examples, reference signal time resources (e.g., PSSCH DMRS symbols) may be non-optimally distributed throughout the slot, and/or may be overwritten by a PSCCH symbol, causing a decreased quantity of reference signals (e.g., relative to slots that do not include PSCCH symbols) which may negatively impact channel estimation. In some examples, even when a total frequency allocation size is larger (e.g., includes a wider frequency range and/or multiple frequency subchannels) than a single subchannel, the demodulation performance of resource elements of the first subchannel, which includes the PSCCH symbols, might be degraded due to non-optimal DMRS symbol locations, which may risk unsuccessful decoding of the entire slot and/or the PSSCH causing wasted resources.

Various aspects relate generally to techniques for increasing reference signal time domain location flexibility. Some aspects more specifically relate to techniques for increasing reference signal time domain location flexibility as applied to single subchannel control channel allocations and/or various portions of a frequency allocation. In some aspects, a transmitting UE may obtain a sidelink control message for transmission. In such aspects, the sidelink control message may at least partially overlap in time with a time domain location of a first set of one or more time domain locations for communicating a data message reference signal (e.g., DMRS) according to a first configuration. For example, the transmitting UE may obtain a sidelink control channel message (e.g., a PSCCH message) and/or may obtain a frequency resource allocation for communicating the sidelink control channel message that includes a single frequency subchannel of a total frequency allocation (e.g., including one or more frequency subchannels). Based on obtaining the sidelink control channel message and/or obtaining a single frequency subchannel allocation for the control channel message, the sidelink control channel message may overlap with and/or be scheduled during a time domain location that would otherwise be used for communicating a reference signal (e.g., according to a different configuration, according to a multiple subchannel allocation, among other examples). For example, transmitting the sidelink control channel message according to a first time domain resource configuration (e.g., a configuration that does not take the control channel transmission into account) may cause an inefficient dispersion of reference signals. Thus, the transmitting UE may transmit the sidelink control channel message and the one or more reference signals according to a flexible time domain location configuration. For example, the transmitting UE may transmit, in accordance with a second configuration, the sidelink control message during the time domain location and a set of data message reference signals during a second set of one or more other time domain locations in accordance with obtaining the sidelink control message. In some aspects, the first configuration may include a first table for determining reference signal time domain locations and the second configuration may include a second table for determining reference signal time domain locations applicable to single subchannel allocations.

In some aspects, a transmitting UE may obtain a sidelink control message for transmission via a first portion of a frequency allocation. In such aspects, the sidelink control message may at least partially overlap in time with a time domain location for communicating a data message reference signal via a second portion of the frequency allocation according to a first configuration. The transmitting UE may transmit, in accordance with a second configuration and via the first portion of the frequency allocation, a first set of data message reference signals in accordance with obtaining the sidelink control message. The transmitting UE may transmit, according to the first configuration and via the second portion of the frequency allocation, a second set of data message reference signals including the data message reference signal.

In some aspects, a transmitting UE may obtain a sidelink control message for transmission via a first frequency subchannel of a set of frequency subchannels. In such aspects, the sidelink control message may at least partially overlaps in time with a time domain location for communicating a data message reference signal via a second frequency subchannel of the set of frequency subchannels according to a first resource configuration. The transmitting UE may transmit, via the first frequency subchannel, a set of data message reference signals according to a second resource configuration of a set of resource configurations in a data message reference signal configuration.

Particular aspects of the subject matter described in this disclosure can be implemented to realize one or more of the following potential advantages. In some examples, the described techniques can be used to increase efficiency and efficacy of receiving UE-side decoding and/or demodulation. For example, by the transmitting UE transmitting, according to the second reference signal configuration, the set of reference signals in accordance with obtaining the sidelink control message, the transmitting UE may increase flexibility of the sidelink system by implementing two reference signal configurations and applying each to an applicable scenario (e.g., single subchannel allocations for control channel messages vs. multi-subchannel allocations for control channel messages). In other aspects, by the transmitting UE transmitting, according to the second reference signal configuration and via the first portion of the frequency allocation, the first set of data message reference signals in accordance with obtaining the sidelink control message, and transmitting, according to the first reference signal configuration and via the second portion of the frequency allocation, the second set of data message reference signals including the reference signal, the transmitting UE may increase an amount of demodulation information and/or more efficiently transmit demodulation information which may enhance demodulation at the receiving UE. In some other examples, by the transmitting UE transmitting, via the first frequency subchannel, the set of data message reference signals according to the second resource configuration of the set of resource configurations in the data message reference signal configuration, the transmitting UE may be free of demodulation reference signal time pattern constraints and may autonomously select a quantity of DMRS symbols to be transmitted which may enabled the transmitting UE to dynamically prioritize channel quality and/or spectral efficiency by adaptively implementing a reference signal resource configuration suited to each scenario.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

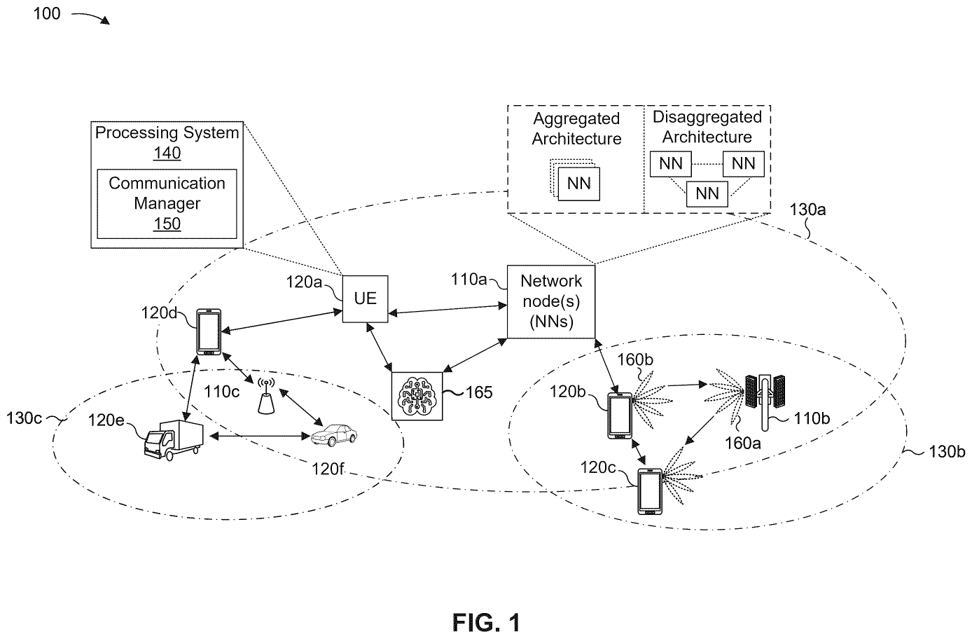

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, a UE 120c, a UE 120d, a UE 120e and a UE 120f. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120. A processing system (for example, the processing system 140) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 may include a memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 may include or be coupled with one or more modems (such as a cellular (for example, a 5G or 6G compliant) modem). In some examples, the processing system 140 include or implement one or more of the modems. The processing system 140 may also include or be coupled with multiple radios (collectively “the radio”), multiple RF chains, or multiple transceivers, each of which may in turn be coupled with one or more of multiple antennas. In some examples, one or more processors of the processing system 140 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

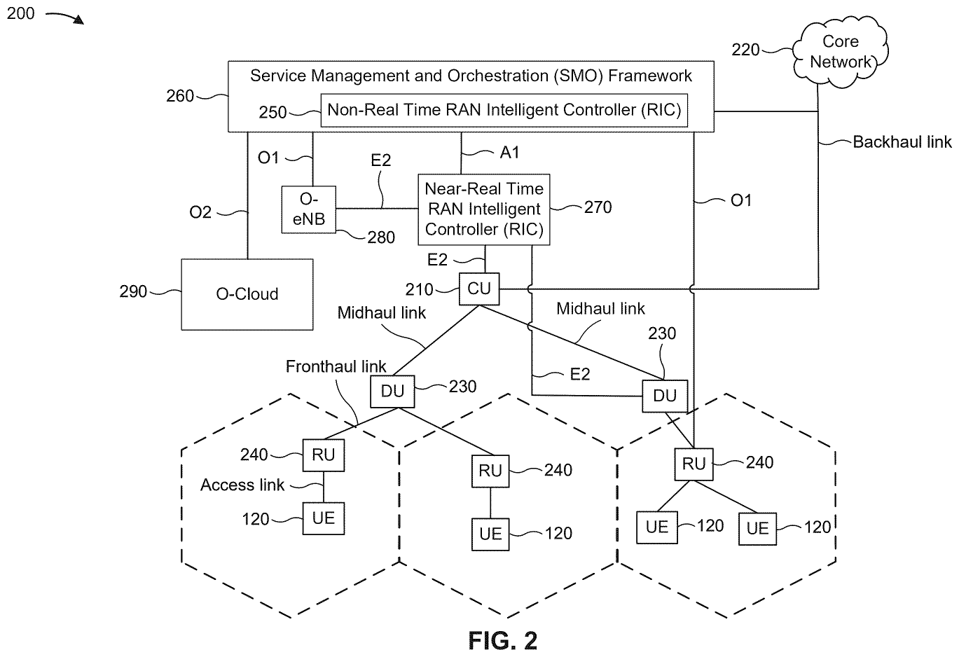

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 140 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110, one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some examples, two or more UEs 120 (for example, shown as UE 120a and UE 120d or the UE 120e and the UE 120f) may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110, which then transmits the data to the UE 120d in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a PSSCH, a PSCCH, and/or a physical sidelink feedback channel (PSFCH).

In some aspects, the UE 120 may include a communication manager 150. As described in more detail elsewhere herein, the communication manager 150 may obtain a sidelink control message for transmission that at least partially overlaps in time with a time domain location of a first set of one or more time domain locations for communicating a data message reference signal according to a first configuration; and transmit, in accordance with a second configuration, the sidelink control message during the time domain location and a set of data message reference signals during a second set of one or more other time domain locations in accordance with obtaining the sidelink control message. Additionally, or alternatively, the communication manager 150 may perform one or more other operations described herein.

As described in more detail elsewhere herein, the communication manager 150 may obtain a sidelink control message for transmission via a first portion of a frequency allocation, wherein the sidelink control message at least partially overlaps in time with a time domain location for communicating a data message reference signal via a second portion of the frequency allocation according to a first configuration; transmit, in accordance with a second configuration and via the first portion of the frequency allocation, a first set of data message reference signals in accordance with obtaining the sidelink control message; and transmit, according to the first configuration and via the second portion of the frequency allocation, a second set of data message reference signals including the data message reference signal. Additionally, or alternatively, the communication manager 150 may perform one or more other operations described herein.

As described in more detail elsewhere herein, the communication manager 150 may obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration; and transmit, via the first frequency subchannel, a set of data message reference signals according to a second resource configuration of a set of resource configurations in a data message reference signal configuration. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

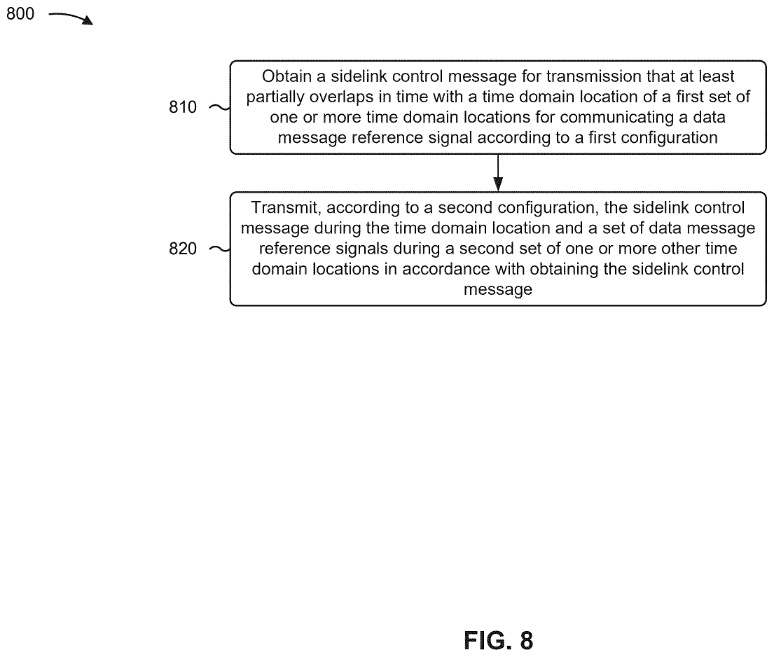

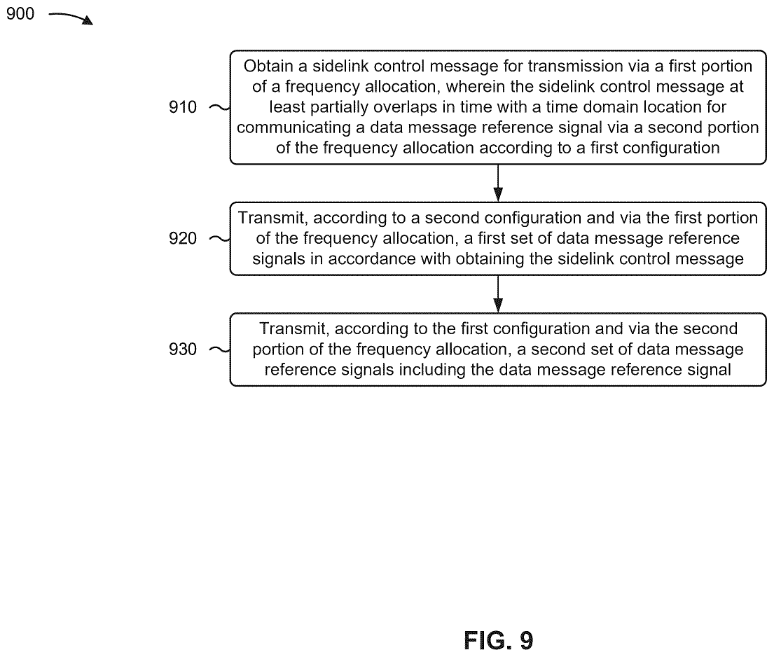

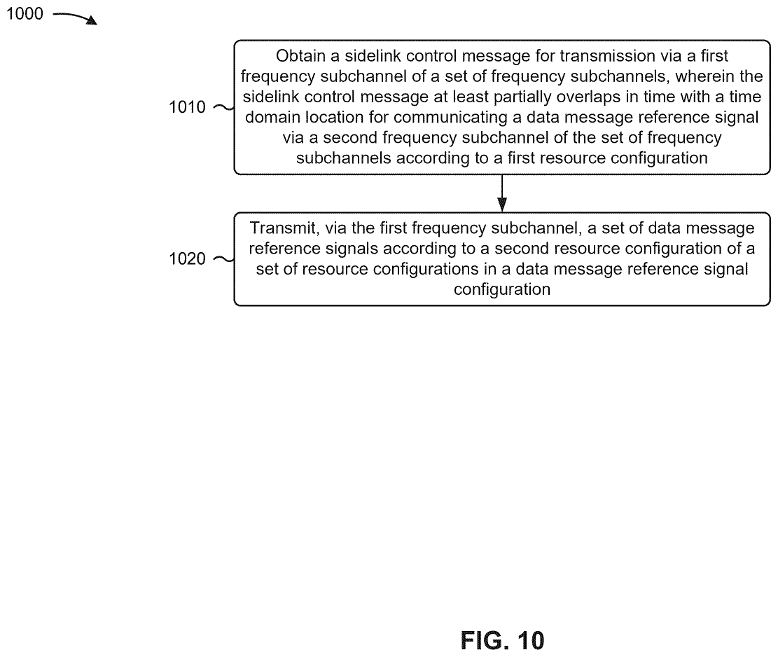

The network node 110, a processing system of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with adaptable slot structure for sidelink communications, as described in more detail elsewhere herein. For example, the processing system 140 of the UE 120, the CU 210, the DU 230, or the RU 240 may perform or direct operations of, for example, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 140) of the network node 110, the UE 120, the CU 210, the DU 230, or the RU 240, may cause the one or more processors to perform process 800 of FIG. 8, process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the transmitting UE 120 includes means for obtaining a sidelink control message for transmission that at least partially overlaps in time with a time domain location of a first set of one or more time domain locations for communicating a data message reference signal according to a first configuration; and/or means for transmitting, in accordance with a second configuration, the sidelink control message during the time domain location and a set of data message reference signals during a second set of one or more other time domain locations in accordance with obtaining the sidelink control message.

In some aspects, the transmitting UE 120 includes means for obtaining a sidelink control message for transmission via a first portion of a frequency allocation, wherein the sidelink control message at least partially overlaps in time with a time domain location for communicating a data message reference signal via a second portion of the frequency allocation according to a first configuration; means for transmitting, in accordance with a second configuration and via the first portion of the frequency allocation, a first set of data message reference signals in accordance with obtaining the sidelink control message; and/or means for transmitting, according to the first configuration and via the second portion of the frequency allocation, a second set of data message reference signals including the data message reference signal.

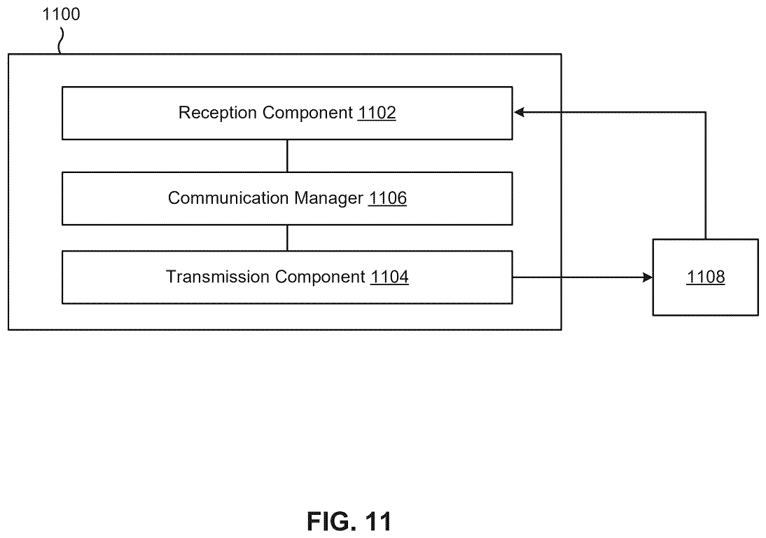

In some aspects, the transmitting UE 120 includes means for obtaining a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration; and/or means for transmitting, via the first frequency subchannel, a set of data message reference signals according to a second resource configuration of a set of resource configurations in a data message reference signal configuration. The means for the transmitting UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

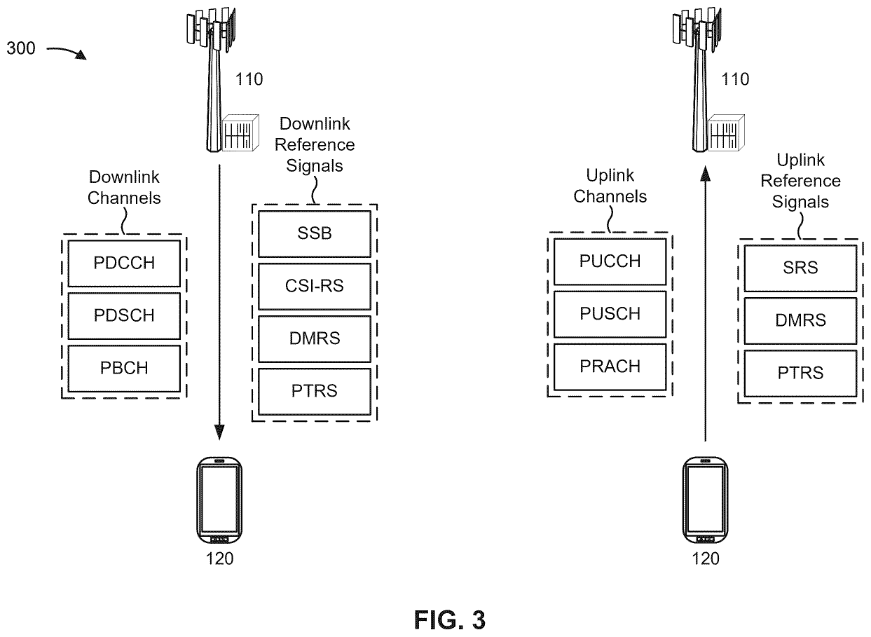

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs may be used for downlink communications and/or uplink communications.

In some examples, a sidelink DMRS may carry information for a receiving UE to use to estimate a radio channel for demodulation of an associated physical channel (e.g., PSSCH). The distribution of DMRSs throughout a time resource may positively or negatively impact decoding and/or demodulation of the physical channel. For example, a space between reference signals may be relatively large, and thus time domain resources may occur without the receiving UE receiving up-to-date decoding (e.g., demodulating) information. In some examples, a first occurring reference signal may not occur in a first occurring time resource of the slot and thus time domain resources may occur without the receiving UE receiving decoding (e.g., demodulating) information. In some examples reference signal time resources (e.g., PSSCH DMRS symbols) may be non-optimally distributed throughout the slot, or may be overwritten by a PSCCH symbol, causing a lack of reference signals, which may negatively impact channel estimation between the receiving UE and a transmitting UE.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

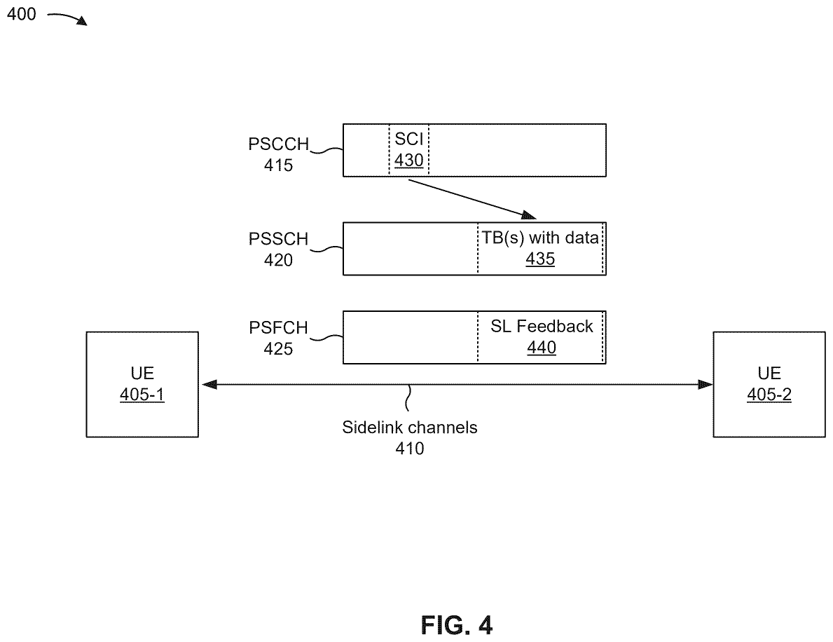

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a PSCCH 415, a PSSCH 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

The structure of time resources for sidelink communications may be flexible. For example, a quantity of sidelink reference signal time resources (e.g., PSSCH DMRS symbols) in a slot may vary. In some examples, the quantity of sidelink reference signal time resources, n, may be n₀ (e.g., 2), n₁ (e.g., 3), or n₂ (e.g., 4). Sidelink time resources structures may be flexible to balance UE mobility considerations with maintaining spectral efficiency. For example, the transmitting UE may adapt the quantity of reference signal time resources in a sidelink transmission according to channel conditions. For example, high mobility scenarios may be associated with lower quality channel conditions and thus, more reference signals may be useful for maintaining a baseline channel estimation quality. In other scenarios, the channel quality may be more stable, and thus fewer reference signals may be transmitted, and the UE may achieve a higher spectral throughput while maintaining channel estimation quality.

The transmitting UE may select the quantity of reference signal time resources according to, or otherwise based on, a reference signal pattern configuration (e.g., sl-PSSCH-DMRS-TimePatternList), such as the reference signal pattern configuration shown in Table 1, below.

TABLE 1
REFERENCE SIGNAL
PATTERN CONFIGURATION

{n₀}
{n₁}
{n₂}
{n₀, n₁}
{n₀, n₂}
{n₁, n₂}
{n₀, n₁, n₂}

The reference signal pattern configuration shown in Table 1 may indicate a single quantity of reference signal time resources and/or may indicate that the UE may select from a plurality of reference signal time resource quantities. A time domain location of each reference signal may be based on a reference signal location configuration (e.g., a PSSCH DMRS time domain location configuration table), as shown in Table 2, below.

TABLE 2

| | Reference Signal Location Configuration | | | | | |
|---|---|---|---|---|---|---|
| 1_{d} in | PSCCH duration 2 symbols | | | PSCCH duration 3 symbols | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 1, 5 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 8 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 11 |

The values in table 2 are examples, and may vary. In some aspects, the location of each reference signal time resource (e.g., PSSCH DMRS symbols) may be dictated by a quantity of sidelink data channel resources (e.g., PSSCH symbols), a quantity of sidelink control channel resources (e.g., PSCCH symbols), and/or a quantity or reference signal resources (e.g., PSSCH DMRS symbols).

As indicated above, FIG. 4 is provided as an example. Other examples may differ from what is described with respect to FIG. 4.

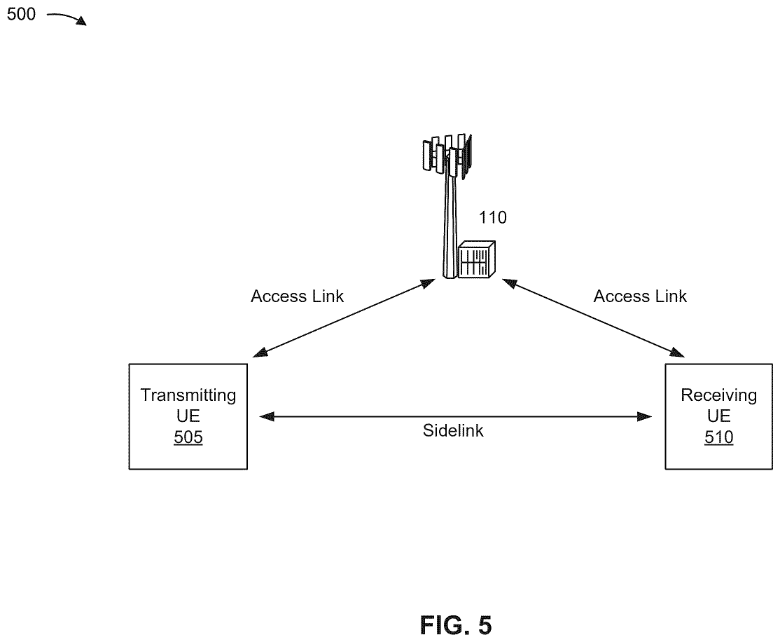

FIG. 5 is a diagram illustrating an example 500 of sidelink communications and access link communications, in accordance with the present disclosure.

As shown in FIG. 5, a transmitting UE 505 and a receiving UE 510 may communicate with one another via a sidelink, as described above in connection with FIG. 4. As further shown, in some sidelink modes, a network node 110 may communicate with the transmitting UE 505 (e.g., directly or via one or more network nodes), such as via a first access link. Additionally, or alternatively, in some sidelink modes, the network node 110 may communicate with the receiving UE 510 (e.g., directly or via one or more network nodes), such as via a first access link. The transmitting UE 505 and/or the receiving UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

Some combinations of the reference signal pattern configuration and the reference signal location configuration, described in connection with FIG. 4, may lead to scenarios in which demodulation by the receiving UE 510 may degrade because the pattern of reference signals may be inefficiently spaced throughout the slot. For example: a space between reference signals transmitted by the transmitting UE 505 may be relatively large, and thus time domain resources may occur without the receiving UE 510 receiving up-to-date decoding (e.g., demodulating) information; a first occurring reference signal may not occur in a first occurring time resource of the slot and thus time domain resources may occur without the receiving UE 510 receiving decoding (e.g., demodulating) information, among other examples. Such degradations may be more impactful when a sidelink control channel allocation size is a single subchannel. In such examples, reference signal time resources (e.g., PSSCH DMRS symbols) may be non-optimally distributed throughout the slot, or may be overwritten by a PSCCH symbol, causing a lack of reference signals, which may negatively impact channel estimation. Even if the frequency allocation size is larger (e.g., includes a wider frequency range and/or multiple frequency subchannels) than a single subchannel, the demodulation performance of REs of the first subchannel, which includes the PSCCH symbols, might be degraded due to non-optimal DMRS symbol locations, which may risk unsuccessful decoding of the entire slot PSSCH.

As indicated above, FIG. 5 is provided as an example. Other examples may differ from what is described with respect to FIG. 5.

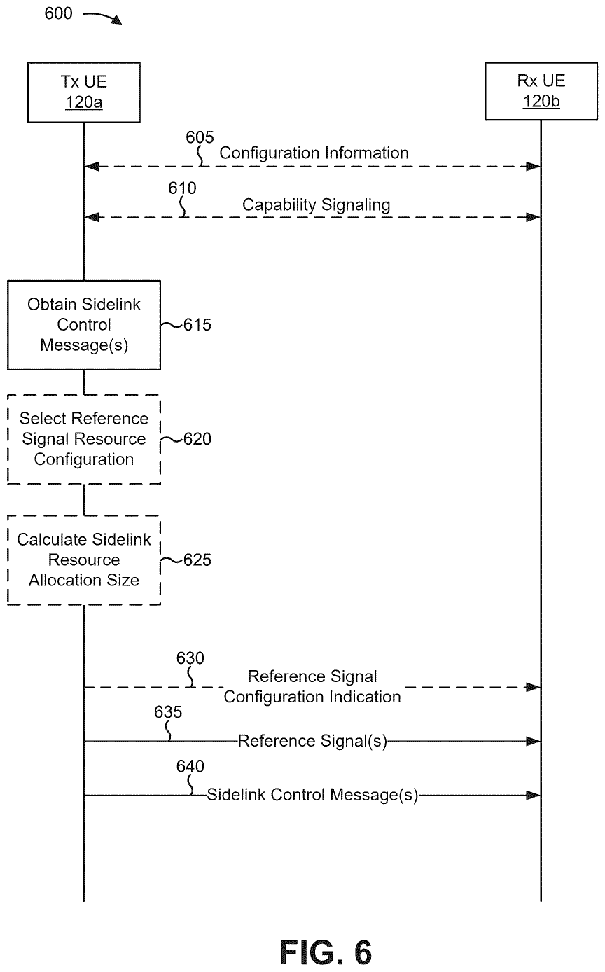

FIG. 6 is a diagram of an example 600 associated with an adaptable slot structure for sidelink communications, in accordance with the present disclosure. As shown in FIG. 6, a transmitting UE 120a (e.g., UE 120 described in connection with FIG. 1) may communicate with a receiving UE 120b (e.g., UE 120 described in connection with FIG. 1). In some aspects, the UE 120a and the UE 120b may be part of a wireless network (e.g., wireless network 100). The UE 120a and the UE 120b may have established a wireless connection prior to operations shown in FIG. 6. The example 600 may support techniques for increasing sidelink control channel time domain location flexibility, for example based on communication conditions and/or parameters, and/or frequency allocation.

As shown by reference number 605, the UE 120a and/or the UE 120b may exchange (e.g., using communication manager 150, communication manager 1106, transmission component 1104, and/or reception component 1102) configuration information. In some aspects, the UE 120a and/or the UE 120b may communicate the configuration information via one or more of system information (e.g., a master information block (MIB) and/or a system information block (SIB), among other examples), radio resource control (RRC) signaling, one or more medium access control (MAC) control elements (CEs), and/or sidelink control information (SCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication (e.g., an indication described herein) May include a dynamic indication, such as one or more MAC CEs and/or one or more SCI messages, among other examples.

The UE 120a and/or the UE 120b may configure itself based at least in part on the configuration information. In some aspects, the UE 120a and/or the UE 120b may be configured to perform one or more operations described herein based at least in part on the configuration information. In some aspects, the UE 120a and/or the UE 120b may be preconfigured with the configuration information and/or may receive the configuration information from a network node.

As shown by reference number 610, the UE 120a and the UE 120b may communicate (e.g., using communication manager 150, transmission component 1104, and/or reception component 1102) capability signaling. For example, the UE 120a may transmit, and the UE 120b may receive, capability signaling indicating one or more capabilities of the UE 120a. Additionally or alternatively, the UE 120b may transmit, and the UE 120a may receive, capability signaling indicating one or more capabilities of the UE 120b. In some other examples, capability information may be exchanged between the UE 120a and/or the UE 120b via a network node via relayed communications. The capability signaling may indicate whether the UE 120a and/or the UE 120b supports a feature and/or one or more parameters related to the feature. For example, the capability information may indicate a capability and/or parameter for adaptable sidelink slot structure. As another example, the capability signaling may indicate a capability and/or parameter for performing multiple channel estimation procedures. One or more operations described herein may be based on capability information of the capability signaling. For example, the UE 120a and/or the UE 120b may perform a communication in accordance with the capability information, or may receive configuration information that is in accordance with the capability information. In some aspects, the capability signaling may indicate UE support for a flexible reference signal configuration and/or dynamic reference signal configuration selection.

In some aspects, the UE 120a and/or the UE 120b may communicate capability signaling indicating that one or more of the UE 120a and/or the UE 120b is capable of transmitting reference signals according to the first reference signal configuration and the second reference signal configuration. In some aspects, the UE 120b may transmit, and the UE 120a may receive, a capability message indicating support for performing a first channel estimation procedure via a first portion of a frequency allocation and a second channel estimation procedure via a second portion of the frequency allocation. In some aspects, transmitting according to the second reference signal resource configuration, as will be described in connection with reference number 635, may be based on a capability for supporting the second reference signal resource configuration.

In some aspects, the configuration information described in connection with reference number 605 and/or the capability signaling described in connection with reference number 610 may include information transmitted via multiple communications. Additionally, or alternatively, the UE 120a and/or UE 120b may transmit the configuration information, or a communication including at least a portion of the configuration information, before and/or after the UE 120b and/or UE 120a transmits the capability signaling, or vice versa. For example, the UE 120a may transmit a first portion of the configuration information before the capability signaling, the UE 120b may transmit at least a portion of the capability signaling, and/or the UE 120b may transmit a second portion of the configuration information after receiving the capability signaling, among other examples.

As shown by reference number 615, the transmitting UE 120a may obtain (e.g., using communication manager 150, and/or reception component 1102) one or more sidelink control messages. For example, in a first aspect, the UE 120a may obtain a sidelink control message for transmission. In such aspects, the sidelink control message may at least partially overlap in time with a time domain location of a first set of one or more time domain locations for communicating a data message reference signal according to a first configuration. In some aspects, the first reference signal configuration may include a reference signal (e.g., PSSCH DMRS) time domain location table, such as Table 4 and/or Table 5 (provided below).

In a second aspect, the UE 120a may obtain a sidelink control message for transmission via a first portion of a frequency allocation. In such examples, the sidelink control message at least partially overlaps in time with a time domain location for communicating a data message reference signal via a second portion of the frequency allocation according to a first configuration. In some aspects, the first reference signal configuration may include a reference signal (e.g., PSSCH DMRS) time domain location table, such as Table 4 and/or Table 5.

In a third aspect, the UE 120a may obtain a sidelink control message for transmission via a first frequency subchannel of a set of frequency subchannels. In such aspects, the sidelink control message may at least partially overlap in time with a time domain location for communicating a data message reference signal via a second frequency subchannel of the set of frequency subchannels according to a first resource configuration. In some aspects, the first reference signal resource configuration may include a reference signal pattern list and/or table, such as Table 3 (provided below), and/or may include (e.g., indicate) a quantity of reference signal time-frequency resources corresponding to a quantity of reference signal time domain resources (e.g., the UE 120a may use a value of

$${N}_{RE}^{DMRS}$$

in a TB size calculation expression, so that the TB size is calculated for an actual number of DMRS symbols to be communicated with the UE 120b).

As shown by reference number 620, the transmitting UE 120a may select (e.g., using communication manager 150, and/or communication manager 1106) a reference signal resource configuration. For example, according to the third aspect, the UE 120a may select a second reference signal resource configuration in accordance with obtaining the sidelink control message. In such aspects, the second reference signal resource configuration may include only a single set of reference signal resource configurations. For example, the UE 120a, according to the third aspect, may be able to select from a set of at least three quantities of reference signals each time the UE 120a obtain a sidelink control channel message for transmission via a single subchannel allocation, each quantity associated with a same quantity of resource elements.

As shown by reference number 625, the transmitting UE 120a may calculate (e.g., using communication manager 150, and/or communication manager 1106) a sidelink resource allocation size. For example, the UE 120a may calculate a size of a sidelink resource allocation, for transmitting the sidelink control message and the set of data message reference signals, using a quantity of time-frequency resources that correspond to a quantity of data message reference signal resources in the second resource configuration.

As shown by reference number 630, the transmitting UE 120a may transmit (e.g., using communication manager 150, communication manager 1106, and/or transmission component 1104), and the receiving UE 120b may receive (e.g., using communication manager 150, communication manager 1106, and/or reception component 1102), a reference signal configuration indication. For example, the UE 120a, according to the first aspect, may transmit, to the UE 120b, an indication that the sidelink control message was transmitted in accordance with the second configuration. For example, the UE 120a may indicate which reference signal time domain location table (e.g., of a set of tables) was or will be used for a slot including a sidelink control channel communication.

The UE 120a, according to the third aspect, may transmit, to the UE 120b, an indication that the sidelink control message was transmitted. For example, the UE 120a may indicate the quantity of data message reference signal resources selected for transmitting the data message reference signal in a slot including a sidelink control channel communication.

As shown by reference number 635, the transmitting UE 120 may transmit (e.g., using communication manager 150, communication manager 1106, and/or transmission component 1104), and the receiving UE 120b may receive (e.g., using communication manager 150, communication manager 1106, and/or reception component 1102), one or more data message reference signals. In some examples of the first aspect, the UE 120a may transmit, in accordance with the second configuration, the set of data message reference signals in accordance with obtaining the sidelink control message. For example, the UE 120a may transmit the set of data message reference signals according to the second reference signal configuration instead of the first reference signal configuration when the first reference signal configuration would cause an inefficient distribution of reference signals and/or for single subchannel allocations.

In some aspects, the first configuration may indicate the first set of one or more reference signal time domain locations for transmitting the set of data message reference signals, and the second configuration may indicate the second set of one or more time domain locations for transmitting the set of data message reference signals. In some aspects, the UE 120a may transmit, via a second frequency subchannel and according to the second reference signal configuration, a second set of reference signals. For example, the UE 120a may transmit reference signals via one or more other frequency subchannel(s) (e.g., that does not include the sidelink control channel message) of a total frequency resource allocation according to the same reference signal configuration as the first frequency subchannel (e.g., that includes the sidelink control channel message). In some other aspects, the UE 120a may transmit reference signals via the remaining frequency subchannel(s) (e.g., that does not include the sidelink control channel message) of a frequency resource allocation according to a different reference signal configuration than the first frequency subchannel (e.g., that includes the sidelink control channel message).

In some aspects the UE 120a may refrain from transmitting, via the first frequency subchannel, the data message reference signal (e.g., the overlapping reference signal) in association with the sidelink control message at least partially overlapping in time with the data message reference signal. In such aspects, the second set of data message reference signals may be larger than the first set of data message reference signals. For example, the second configuration may include fewer reference signals than the first reference signal configuration, and/or the second configuration may indicate different quantities of reference signals for the first frequency subchannel than any other frequency subchannels (e.g., when allocated for reference signal communication). In such aspects, the data message reference signals according to the second reference signal configuration may be distributed throughout the time slot such that the distribution of reference signals accounts for the fewer quantity of data message reference signals. In some aspects, the UE 120a may transmit, via the second frequency subchannel during a same time resource than the sidelink control message, the data message reference signal in association with the sidelink control message at least partially overlapping in time with the data message reference signal. In such aspects, the second set of data message reference signals and the first set of data message reference signals may each include a same quantity of data message reference signals. For example, the second configuration may include the same quantity of data message reference signals as the first configuration. In such aspects, the data message reference signals of the second reference signal configuration may be distributed throughout the time slot such that the distribution of reference signals accounts avoids the transmission of the reference signal during a same time resource as the sidelink control channel message.

In some aspects, the UE 120a may transmit, via a first portion of the first frequency subchannel, the sidelink control message, and may transmit, via a second portion of the first frequency subchannel during a same time resource as the sidelink control message, the data message reference signal in association with the sidelink control message at least partially overlapping in time with the data message reference signal. In such aspects, the second set of data message reference signals and the first set of data message reference signals each have a same quantity of data message reference signals. For example, the second configuration may indicate the same quantity of reference signals as the first configuration. In such aspects, the data message reference signals of the second configuration may be distributed throughout the time slot such that the distribution of reference signals accounts avoids large time gaps between reference signals after transmission of the sidelink control channel message and transmission of the reference signal during the same time resource as the sidelink control channel message. This scenario may prioritize channel quality over spectral efficiency.

In some aspects, each reference signal time domain location of the first configuration may correspond to a “fallback” entry (e.g., a conditional entry which the UE 120a may implement when a certain condition is met and/or triggered) for sidelink control channel communications via a single frequency subchannel. In such aspects, the fallback entries may comprise the second configuration.

In some examples of the second aspect, the UE 120a may transmit, in accordance with a second configuration and via the first portion of the frequency allocation, a first set of data message reference signals in accordance with obtaining the sidelink control message, and may transmit, according to the first reference signal configuration and via the second portion of the frequency allocation, a second set of data message reference signals including the data message reference signal. For example, the UE 120a may transmit some reference signals according to a first configuration and some other reference signals in accordance with a second configuration, to adapt different portions of a frequency allocation for transmitting various combinations of sidelink messages, such as control channel information and/or reference signals. In some aspects, the second configuration may be associated with single subchannel communications including one or more sidelink control messages.

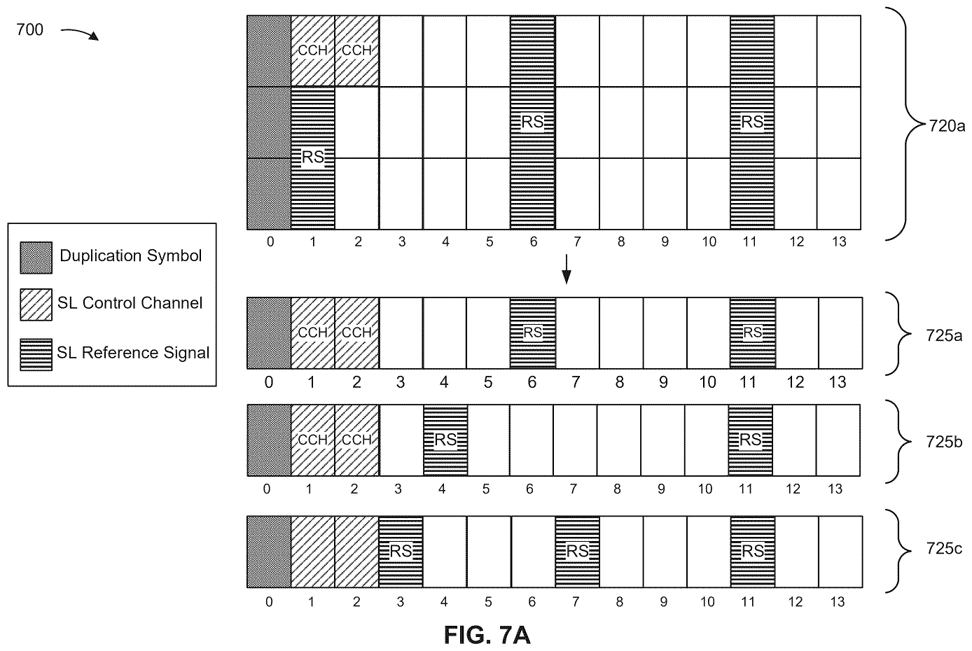

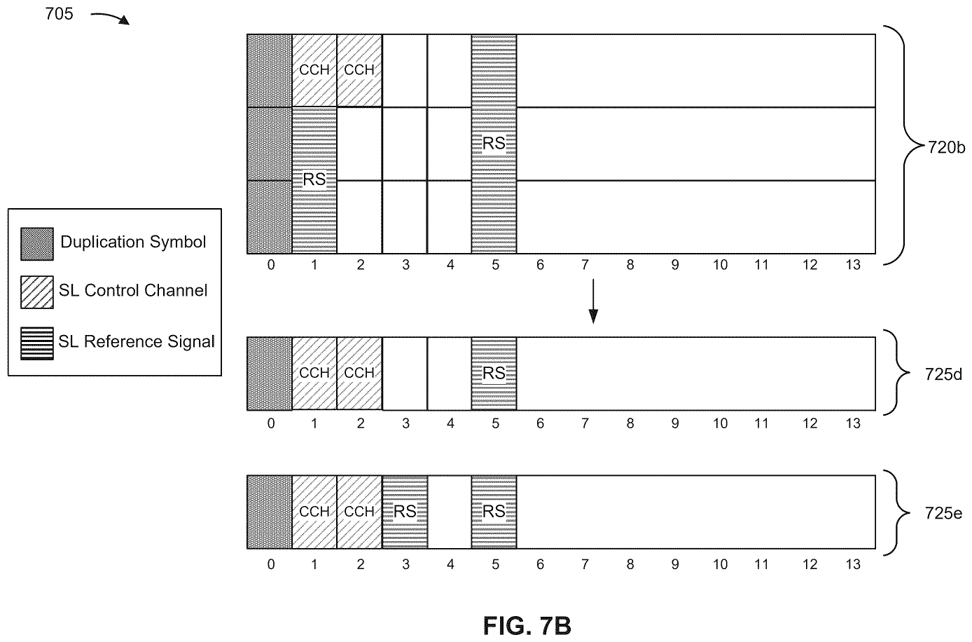

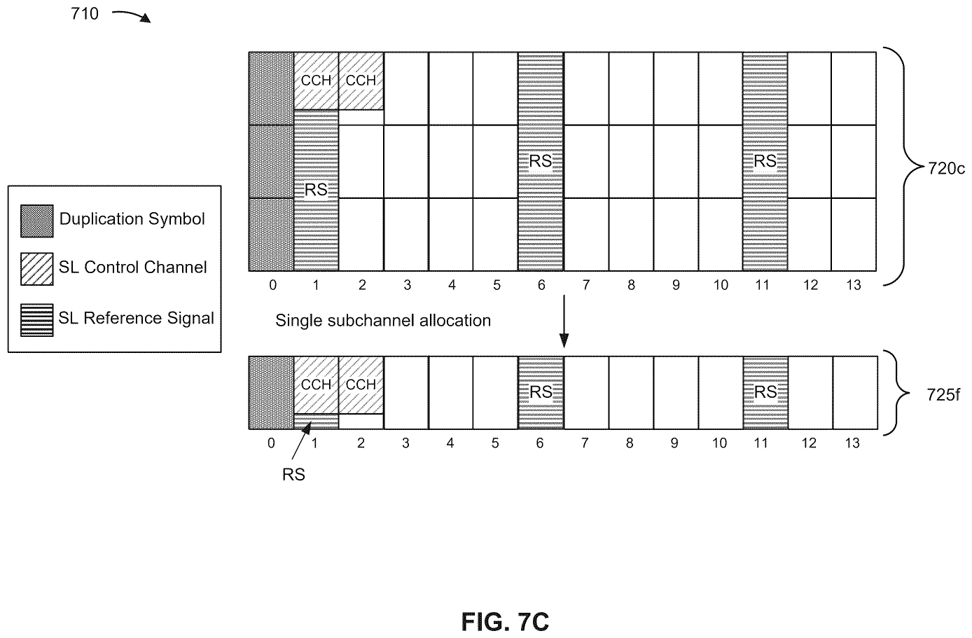

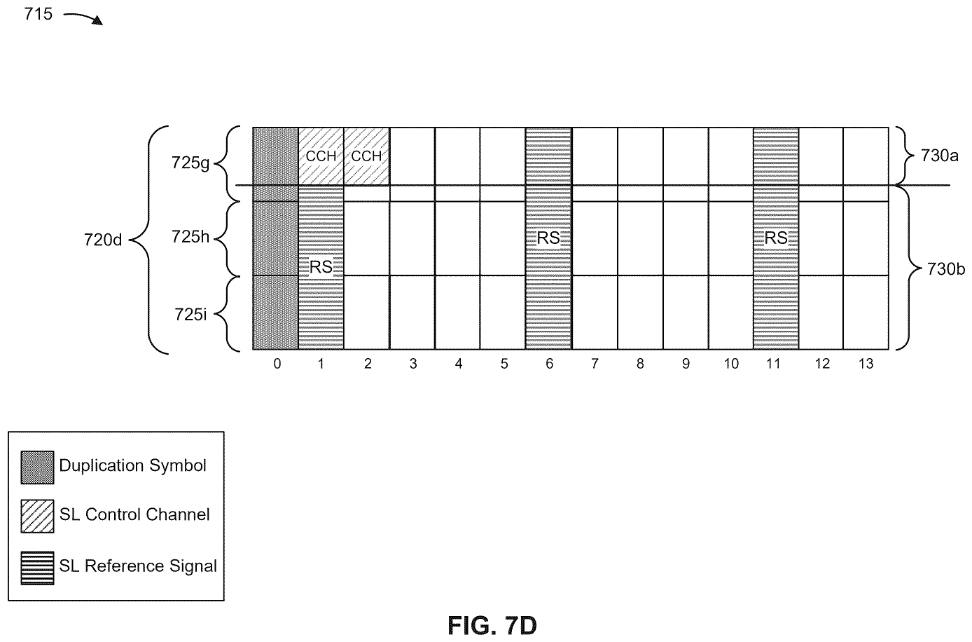

In some aspects, the second set of data message reference signals may include a quantity of data message reference signals that is equal to or is greater than a quantity of data message reference signals included in the first set of data message reference signals. In some aspects, the first set of data message reference signals may be transmitted via a first set of time resources and the second set of reference signals may be transmitted via a second set of time resources that at least partially overlaps with the first set of time resources. In some aspects, the first portion of the frequency allocation may include a first frequency subchannel of a set of frequency subchannels and the second portion of the frequency allocation may include a second frequency subchannel of the set of frequency subchannels. In some other aspects, the first portion of the frequency allocation may include a portion of a first frequency subchannel of a set of frequency subchannels, and the second portion of the frequency allocation may include a second portion of the first frequency subchannel and a second frequency subchannel of the set of frequency subchannels (e.g., as illustrated with reference to FIGS. 7C and 7D).

In some aspects, the first configuration may include a first set of one or more time domain locations for the set of data message reference signals and the second configuration may include a second set of one or more time domain locations for the set of data message reference signals.

In some examples of the third aspect, the UE 120a may transmit, via the first frequency subchannel, a set of reference signals according to a second reference signal resource configuration of a set of reference signal resource configurations in a reference signal configuration. For example, the UE 120a may implement some RAT protocols, such as wireless communication protocols associated with 6G communications and/or beyond 6G communications, and may transmit the reference signals in association with a reference signal resource configuration that is different from a reference signal resource configuration implemented by other UEs communicating according to other RAT protocols. In some aspects, the set of reference signal resource configurations associated with 6G (e.g., and beyond) RAT protocols may include a configuration and/or table having a single entry of three selectable reference signal resource configurations, each indicating a quantity of reference signal time domain resources and each associated with a same quantity of resource elements. In some other aspects, the set of reference signal resource configurations associated with 6G (e.g., and beyond) RAT protocols may include a quantity of resource elements that is adaptable by the UE 120a (e.g., the UE 120a may select a value) to apply to a quantity of reference signals.

In some aspects, according to the third aspect, each resource configuration of the set of data message reference signal configurations may be associated with a same quantity of time-frequency resources.

In any of the aspects described, the UE 120a may determine that because the UE 120a has obtained a sidelink control channel message for transmission via a single subchannel allocation, a data message reference signal pattern in a time slot may cause communication errors and/or degraded channel quality. Thus, the UE 120a may implement any of the aspects described herein to adapt the slot structure to transmit the reference signals in such a way that demodulation and/or decoding at the UE 120b is maintained, minimally degraded, and/or enhanced. In some other aspects, the UE 120a may determine that the UE 120a has obtained a sidelink control channel message for transmission via a single subchannel allocation, and thus may implement any of the aspects described herein.

In some aspects, the UE 120a may transmit, via the second frequency subchannel and according to the second resource configuration, a second set of data message reference signals. In some such aspects, the UE 120a may refrain from transmitting, via the first frequency subchannel, the data message reference signal in association with the sidelink control message at least partially overlapping in time with the data message reference signal, and the second set of data message reference signals may be larger than the set of reference signals. In some aspects, the UE 120a may transmit, via the second frequency subchannel during a different time resource than the sidelink control message, the reference signal in association with the sidelink control message at least partially overlapping in time with the reference signal. In such aspects, the second set of reference signals and the first set of reference signals may each have a same quantity of reference signals.

In some aspects, the UE 120a may transmit, via a first portion of the first frequency subchannel, the sidelink control message, and may transmit, via a second portion of the first frequency subchannel during a same time resource as the sidelink control message, the data message reference signal in association with the sidelink control message at least partially overlapping in time with the data message reference signal. In such aspects, the second set of data message reference signals and the first set of data message reference signals may each have a same quantity of reference signals.

As shown by reference number 640, the transmitting UE 120a may transmit (e.g., using communication manager 150, communication manager 1106, and/or transmission component 1104), and the receiving UE 120b may receive (e.g., using communication manager 150, communication manager 1106, and/or reception component 1102), one or more sidelink control messages. For example, in the first aspect, the UE 120a may transmit, and the UE 120b may receive, the sidelink control message in association with transmitting the set of data message reference signals in accordance with the second configuration.

In the second aspect, the UE 120a may transmit, via the first portion of the frequency allocation and in accordance with the second configuration, the sidelink control message in association with transmitting the first set of data message reference signals.

In the third aspect, the UE 120a may transmit the sidelink control message in association with transmitting the set of data message reference signals according to the second resource configuration.

As indicated above, FIG. 6 is provided as an example. Other examples may differ from what is described with respect to FIG. 6.

FIG. 7A is a diagram illustrating an example 700 associated with a slot structure for communicating sidelink control information and sidelink reference signals, in accordance with the present disclosure. As shown in FIG. 7A, example 700 includes a multi-subchannel resource allocation for transmitting sidelink control information via a single subchannel. Specifically, example 700 depicts three subchannels. However, the techniques described herein may be applied to various frequency resource allocation configurations.

In the example 700, the frequency allocation 720a, according to a first reference signal configuration and/or a first reference signal resource configuration, may include two PSCCH symbols, 13 data symbols, and three DMRS symbols. As a result, the subchannel configuration 725a (e.g., an example configuration for the first subchannel) may include three time resources before a reference signal is communicated in which generating a channel estimation extrapolation of symbols 3, 4 and 5 (e.g., for the first subchannel), may degrade demodulation performance at a receiving UE.

Better performance may be achieved by using a three or more DMRS symbol configuration in which a DMRS symbol is overwritten by a CCH symbol and two DMRS symbols are transmitted, as shown in subchannel configuration 725b (e.g., an example configuration for a single subchannel allocation). However, if the first reference signal configuration and/or the first reference signal resource configuration does not include an option for two reference signals, the transmitting UE may be prevented from transmitting the two reference signals in a pattern that supports efficient channel estimation (e.g., would transmit two DMRS according to a three or four DMRS configuration).

The subchannel configuration 725c (e.g., an example configuration for the first subchannel) may include a new slot structure according to a second reference signal configuration and/or a second reference signal resource configuration. In such aspects, efficiency may depend on a Doppler spread.

FIG. 7B is a diagram illustrating an example 705 associated with a slot structure for communicating sidelink control information and sidelink reference signals, in accordance with the present disclosure. As shown in FIG. 7B, example 705 includes a multi-subchannel resource allocation for transmitting sidelink control information via a single subchannel. Specifically, example 705 depicts three subchannels. However, the techniques described herein may be applied to various frequency resource allocation configurations.

In the example 705, the frequency allocation 720b, according to a first reference signal configuration and/or a first reference signal resource configuration, may include two PSCCH symbols, six data symbols and two DMRS symbols. As a result, the subchannel configuration 725d (e.g., an example configuration for the first subchannel) may include a single DMRS, which may inhibit carrier frequency offset estimation, and may enable zero-order hold CHEST without enabling other types of channel estimation procedures. In such examples, decoding may fail due to an uncorrected frequency offset and/or insufficient channel estimation quality.

According to the techniques described herein, the subchannel configuration 725e (e.g., an example configuration for the first subchannel) may include a new slot structure (e.g., having two DMRS symbols, but at different locations (e.g., symbols 3 and 5)).

In some aspects, techniques for determining a quantity of DMRS symbols may be redefined to include adaptable techniques. For example, a new technique may remove reference symbol quantity restrictions indicated by the parameter, sl-PSSCH-DMRS-TimePatternList-r16. In such aspects, the transmitting UE may autonomously determine a quantity of DMRS symbols to be transmitted out of three options, {n₁, n₂, n₃) (e.g., in some techniques the three options may include 2, 3, or 4). For example, all entries except the last entry of Table 3 may be removed and/or ignored.

Enabling the transmitting UE to select a quantity of reference signals for each sidelink reference signal transmission may avoid large gaps between reference signals, such as shown in the subchannel configuration 725a in which three time resources pass before a reference signal is communicated, and/or the subchannel configuration 725b in which an initial reference signal is received promptly but there is a gap between reference signals of six slots. For example, the transmitting UE may select three reference signal resources as shown in the subchannel configuration 725c such that an initial reference signal is received promptly and large gaps between reference signals are avoided.

In some other aspects, a parameter, such as sl-PSSCH-DMRS-TimePatternList, may be used for TB size calculation (e.g., by setting

$${N}_{RE}^{DMRS}$$

in the calculation according to using Table 3 below). Thus, a same calculated TB size may be achieved regardless of the actual quantity of DMRS symbols, and the TB size may remain the same for initial transmissions and retransmissions.

Removal of all entries except the last entry in Table 3 may increase optional deviation from a desired code rate (e.g., for both sidelink directions) due to non-accurate calculation of available resources, but may enable the increased flexibility of the slot structure.

Additionally or alternatively, the value of

$${N}_{RE}^{DMRS}$$

in the TB size calculation expression may be set according to an actual quantity of DMRS symbols, for example, instead of according to a reference signal pattern configuration, such as sl-PSSCH-DMRS-TimePatternList. To maintain TB size for both initial transmission and retransmission in this scenario, the transmitting UE may use the same quantity of DMRS symbols for each transmission of the same TB.

TABLE 3

| REFERENCE SIGNAL | |
|---|---|
| PATTERN CONFIGURATION | ${N}_{R E}^{DMRS}$ |
| {n₀} (e.g., {2}) | ${N}_{R E 0}^{DMRS} ( e . g . , 12 )$ |
| {n₁} (e.g., {3}) | ${N}_{RE 1}^{DMRS} ( e . g . , 18 )$ |
| {n₂} (e.g., {4}) | ${N}_{RE 2}^{DMRS} ( e . g . , 24 )$ |
| {n₀, n₁} (e.g., {2, 3}) | ${N}_{RE 3}^{DMRS} ( e . g . , 15 )$ |
| {n₀, n₂} (e.g., {2, 4}) | ${N}_{RE 1}^{DMRS} ( e . g . , 18 )$ |
| {n₁, n₂} (e.g., {3, 4}) | ${N}_{RE 4}^{DMRS} ( e . g . , 21 )$ |
| {n₀, n₁, n₂} (e.g., {2, 3, 4}) | ${N}_{RE 1}^{DMRS} ( 18 )$ |

In some aspects, an additional reference signal configuration (e.g., in addition to Table 2), such as a DMRS position table may be defined such that the transmitting UE may switch between tables (e.g., Table 4 (e.g., which may be similar to Table 2) and/or Table 5) for determining slot structure. For example, a second reference signal configuration (e.g., Table 5) may be defined to more efficiently suit scenarios in which a single subchannel (e.g., or less) is allocated for sidelink control channel transmissions in which PSCCH symbols overlap PSSCH DMRS symbols.

TABLE 4

| | Reference Signal Location Configuration | | | | | |
|---|---|---|---|---|---|---|
| 1_{d} in | PSCCH duration 2 symbols | | | PSCCH duration 3 symbols | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 1, 5 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 8 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 11 |

TABLE 5

| | DMRS position | | | | | |
|---|---|---|---|---|---|---|
| 1_{d} in | PSCCH duration 2 symbols | | | PSCCH duration 3 symbols | | |
| symbols | 2 | 3 | 4 | 2 | 3 | 4 |
| 6 | 3, 5 | | | N/A | | |
| 7 | 3, 6 | | | 4, 6 | | |
| 8 | 3, 7 | | | 4, 7 | | |
| 9 | 3, 8 | 3, 5, 7 | | 4, 8 | 4, 6, 8 | |
| 10 | 3, 8 | 4, 6, 8 | | 4, 8 | 4, 6, 8 | |
| 11 | 3, 10 | 3, 6, 9 | 3, 5, 7, 9 | 4, 10 | 4, 7, 10 | 4, 6, 8, 10 |
| 12 | 3, 10 | 4, 7, 10 | 4, 6, 8, 10 | 4, 10 | 4, 7, 10 | 4, 6, 8, 10 |
| 13 | 3, 10 | 4, 7, 10 | 4, 6, 8, 10 | 4, 11 | 4, 8, 12 | 5, 7, 9, 11 |

In some aspects, the transmitting UE and the receiving UE may both have information associated with the allocation size and/or content, for example communicated via an SCI-1 payload, and thus may select Table 5 for single subchannel allocations, and may select Table 4 for all other cases. The specific values represented in Tables 4 and 5 are examples and may vary from actual implementations.

In some aspects, the transmitting UE may include an additional bit in an SCI-1 payload which may signal to the receiving UE which reference signal configuration was used by the transmitting UE. This option may adapt the slot structure according to the actual allocation size and scenario.

In some aspects, with or without the addition bit, a “fallback” entry may be defined for each existing entry in the Table 4. For example, a fallback for entry l_{d}=13, 2 PSCCH, in which there are 3 DMRS at slots 1, 6, and 11 would be l_{d}=13, 2 PSCCH, in which there are 2 DMRS at slots 3, and 10. That is, the fallback reference signal pattern may be determined in relation to a default reference signal pattern when communicating sidelink control channel messages via a single subchannel.

FIG. 7C is a diagram illustrating an example 710 associated with a slot structure for communicating sidelink control information and sidelink reference signals, in accordance with the present disclosure. As shown in FIG. 7C, example 710 includes a multi-subchannel resource allocation 720c for transmitting sidelink control information via a single subchannel.

In the example 710, a subchannel configuration 725f may include a resource allocation for sidelink control channel messaging that may be less than a frequency subchannel of the multi-subchannel resource allocation 720c. In such examples, overall performance without adaptable sidelink slot structure may be less clear and/or dependent on factors such as mobility, or receiving UE capability, among other examples. As discussed below with respect to FIG. 7D, a receiving UE may perform separate channel estimation procedures for a portion of the allocation 720c and/or 720d (as also shown in the subchannel configuration 725f) including the sidelink control channel and a portion of the allocation 720c and/or 720d not including the sidelink control channel. Specifically, examples 710 and 715 each depict three subchannels. However, the techniques described herein may be applied to various frequency resource allocation configurations.

FIG. 7D is a diagram illustrating an example 715 associated with a slot structure for communicating sidelink control information and sidelink reference signals, in accordance with the present disclosure. As shown in FIG. 7D, example 715 includes a multi-subchannel resource allocation for transmitting sidelink control information via a single subchannel. The slot structure of example 715 may be distributed over a frequency allocation 720d having a first portion 730a and a second portion 730b. In some aspects, the first portion 730a may include a first frequency subchannel 725g and/or a portion of the frequency subchannel 725g (as illustrated in FIG. 7D). In some aspects, the second portion 730b may include one or more other frequency subchannels (e.g., frequency subchannels 725h and 725i), and/or may include a remaining portion of the first frequency subchannel 725g and one or more other frequency subchannels (e.g., frequency subchannels 725h and 725i) (as illustrated in FIG. 7D).

The example 715 may be based on and/or associated with a multi-configuration scenario in which a first reference signal configuration includes a resource allocation for communicating sidelink control information and sidelink reference signals and a second reference signal configuration includes a resource allocation for communicating sidelink reference signals (e.g., without sidelink control information). For example, a UE performing sidelink communications according to the example 715 may communicate according to two or more time domain resource tables (e.g., reference signal resource configurations) (e.g., time domain resource tables as described with reference to FIGS. 7A-7C) including at least a first table that is suitable for a PSSCH frequency allocation that does not include a PSCCH message and a second table that is suitable for a PSSCH frequency allocation in which a same frequency range includes a PSCCH message (e.g., transmitted during the first symbols of the time domain allocation).

In the example 715, a transmitting UE and/or a receiving UE may communicate the sidelink information according to a same entry of a same time domain resource table, for example an entry corresponding to a quantity of PSSCH DMRS symbols indicated by SCI (e.g., SCI-1). In the first portion 730a of the frequency resource allocation 720d (e.g., the portion including the PSCCH message), the transmitting UE and/or the receiving UE may communicate the sidelink DMRS and/or the sidelink control message (e.g., PSSCH) according to the second table (e.g., that is suitable for a PSSCH frequency allocation in which a same frequency range includes a PSCCH message). In a second portion 730b of the frequency resource allocation 720d (e.g., the portion not including the PSCCH message), the transmitting UE and/or the receiving UE may communicate the sidelink DMRS according to the first table (e.g., that is suitable for a PSSCH frequency allocation that does not include a PSCCH message).

To communicate using the first and second tables, the receiving UE may have a capability for performing at least two channel estimation procedures. For example, the UE may be capable of performing a CHEST procedure for the first subchannel 725g and/or the first portion 730a of a total frequency allocation 720d (e.g., according to the DMRS symbol pattern of the first portion and/or subchannel) and performing a separate CHEST procedure for remaining subchannels (e.g., subchannels 725h and 725i) of the frequency allocation 720d and/or the second portion 730b of the total frequency allocation (e.g., according to the DMRS symbol pattern of the remaining subchannels).

As indicated above, FIGS. 7A-7D are provided as examples. Other examples may differ from what is described with respect to FIG. 7A-7D.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with adaptable slot structure for sidelink communications.

As shown in FIG. 8, in some aspects, process 800 may include obtaining a sidelink control message for transmission that at least partially overlaps in time with a time domain location of a first set of one or more time domain locations for communicating a data message reference signal according to a first configuration (block 810). For example, the UE (e.g., using reception component 1102 and/or communication manager 1106, depicted in FIG. 11) may obtain a sidelink control message for transmission that at least partially overlaps in time with a time domain location of a first set of one or more time domain locations for communicating a data message reference signal according to a first configuration, as described above in connection with reference number 615 of FIG. 6.

As further shown in FIG. 8, in some aspects, process 800 may include transmitting, in accordance with a second configuration, the sidelink control message during the time domain location and a set of data message reference signals during a second set of one or more other time domain locations in accordance with obtaining the sidelink control message (block 820). For example, the UE (e.g., using transmission component 1104 and/or communication manager 1106, depicted in FIG. 11) may transmit, in accordance with a second configuration, the sidelink control message during the time domain location and a set of data message reference signals during a second set of one or more other time domain locations in accordance with obtaining the sidelink control message, as described above in connection with reference number 635 of FIG. 6.

Process 800 may include additional aspects, such as any single aspect or any combination of aspects described below and/or in connection with one or more other processes described elsewhere herein.

In a first aspect, the first configuration indicates the first set of one or more time domain locations for transmitting the set of data message reference signals, and the second configuration indicates the second set of one or more time domain locations for transmitting the set of data message reference signals.

In a second aspect, alone or in combination with the first aspect, process 800 includes transmitting the sidelink control message in association with transmitting the set of data message reference signals in accordance with the second configuration.

In a third aspect, alone or in combination with one or more of the first and second aspects, process 800 includes transmitting, to a receiving UE, an indication that the sidelink control message was transmitted in accordance with the second configuration.

In a fourth aspect, alone or in combination with one or more of the first through third aspects, the first configuration includes a first set of one or more time domain locations, for communicating sidelink control messages, corresponding to a second set of time domain locations, of the second configuration, for communicating sidelink control messages.

In a fifth aspect, alone or in combination with one or more of the first through fourth aspects, process 800 includes receiving a frequency resource allocation for transmitting the sidelink control message indicating a single frequency subchannel, wherein transmitting the sidelink control message in accordance with the second configuration is associated with the frequency resource allocation indicating a single frequency subchannel.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with adaptable slot structure for sidelink communications.

As shown in FIG. 9, in some aspects, process 900 may include obtaining a sidelink control message for transmission via a first portion of a frequency allocation, wherein the sidelink control message at least partially overlaps in time with a time domain location for communicating a data message reference signal via a second portion of the frequency allocation according to a first configuration (block 910). For example, the UE (e.g., using reception component 1102 and/or communication manager 1106, depicted in FIG. 11) may obtain a sidelink control message for transmission via a first portion of a frequency allocation, wherein the sidelink control message at least partially overlaps in time with a time domain location for communicating a data message reference signal via a second portion of the frequency allocation according to a first configuration, as described above in connection with reference number 615 of FIG. 6.

As further shown in FIG. 9, in some aspects, process 900 may include transmitting, in accordance with a second configuration and via the first portion of the frequency allocation, a first set of data message reference signals in accordance with obtaining the sidelink control message (block 920). For example, the UE (e.g., using transmission component 1104 and/or communication manager 1106, depicted in FIG. 11) may transmit, in accordance with a second configuration and via the first portion of the frequency allocation, a first set of data message reference signals in accordance with obtaining the sidelink control message, as described above in connection with reference number 635 of FIG. 6.

As further shown in FIG. 9, in some aspects, process 900 may include transmitting, according to the first configuration and via the second portion of the frequency allocation, a second set of data message reference signals including the data message reference signal (block 930). For example, the UE (e.g., using transmission component 1104 and/or communication manager 1106, depicted in FIG. 11) may transmit, according to the first configuration and via the second portion of the frequency allocation, a second set of data message reference signals including the data message reference signal, as described above in connection with reference number 635 of FIG. 6.

Process 900 may include additional aspects, such as any single aspect or any combination of aspects described below and/or in connection with one or more other processes described elsewhere herein.

In a first aspect, transmitting in accordance with the second configuration is based on a capability for supporting the second configuration.

In a second aspect, alone or in combination with the first aspect, process 900 includes communicating, with a receiving UE, capability signaling indicating that one or more of the transmitting UE or the receiving UE is capable of transmitting data message reference signals according to the first configuration and the second configuration.

In a third aspect, alone or in combination with one or more of the first and second aspects, process 900 includes receiving, from a receiving UE, a capability message indicating support for performing a first channel estimation procedure via the first portion of the frequency allocation and a second channel estimation procedure via the second portion of the frequency allocation.

In a fourth aspect, alone or in combination with one or more of the first through third aspects, the second configuration is associated with communications including one or more sidelink control messages.

In a fifth aspect, alone or in combination with one or more of the first through fourth aspects, the second set of data message reference signals includes a quantity of data message reference signals that is equal to or greater than a quantity of data message reference signals included in the first set of data message reference signals.

In a sixth aspect, alone or in combination with one or more of the first through fifth aspects, the first set of data message reference signals is transmitted via a first set of time resources and the second set of data message reference signals is transmitted via a second set of time resources that at least partially overlaps with the first set of time resources.

In a seventh aspect, alone or in combination with one or more of the first through sixth aspects, the first portion of the frequency allocation includes a first frequency subchannel of a set of frequency subchannels and the second portion of the frequency allocation includes a second frequency subchannel of the set of frequency subchannels.

In an eighth aspect, alone or in combination with one or more of the first through seventh aspects, the first portion of the frequency allocation includes a portion of a first frequency subchannel of a set of frequency subchannels, and the second portion of the frequency allocation includes a second portion of the first frequency subchannel and a second frequency subchannel of the set of frequency subchannels.

In a ninth aspect, alone or in combination with one or more of the first through eighth aspects, the first configuration includes a first set of one or more time domain locations for the set of data message reference signals and the second configuration includes a second set of one or more time domain locations for the set of data message reference signals.

In a tenth aspect, alone or in combination with one or more of the first through ninth aspects, process 900 includes transmitting, via the first portion of the frequency allocation, the sidelink control message in association with transmitting the first set of data message reference signals.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with adaptable slot structure for sidelink communications.

As shown in FIG. 10, in some aspects, process 1000 may include obtaining a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration (block 1010). For example, the UE (e.g., using reception component 1102 and/or communication manager 1106, depicted in FIG. 11) may obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration, as described above in connection with reference number 615 of FIG. 6.

As further shown in FIG. 10, in some aspects, process 1000 may include transmitting, via the first frequency subchannel, a set of data message reference signals according to a second resource configuration of a set of resource configurations in a data message reference signal configuration (block 1020). For example, the UE (e.g., using transmission component 1104 and/or communication manager 1106, depicted in FIG. 11) may transmit, via the first frequency subchannel, a set of data message reference signals according to a second resource configuration of a set of resource configurations in a data message reference signal configuration, as described above in connection with reference number 635 of FIG. 6.

Process 1000 may include additional aspects, such as any single aspect or any combination of aspects described below and/or in connection with one or more other processes described elsewhere herein.

In a first aspect, each resource configuration of the set of resource configurations is associated with a same quantity of time-frequency resources.

In a second aspect, alone or in combination with the first aspect, process 1000 includes selecting the second resource configuration in accordance with obtaining the sidelink control message.

In a third aspect, alone or in combination with one or more of the first and second aspects, the second resource configuration includes only a single set of resource configurations.

In a fourth aspect, alone or in combination with one or more of the first through third aspects, process 1000 includes calculating a size of a sidelink resource allocation, for transmitting the sidelink control message and the set of data message reference signals, using a quantity of time-frequency resources that correspond to a quantity of data message reference signal resources in the second resource configuration.

In a fifth aspect, alone or in combination with one or more of the first through fourth aspects, process 1000 includes transmitting the sidelink control message in association with transmitting the set of data message reference signals according to the second resource configuration.

In a sixth aspect, alone or in combination with one or more of the first through fifth aspects, process 1000 includes transmitting, to a receiving UE, an indication that the sidelink control message was transmitted.

In a seventh aspect, alone or in combination with one or more of the first through sixth aspects, process 1000 includes transmitting, via the second frequency subchannel and according to the second resource configuration, a second set of data message reference signals.

In an eighth aspect, alone or in combination with one or more of the first through seventh aspects, process 1000 includes refraining from transmitting, via the first frequency subchannel, the data message reference signal in association with the sidelink control message at least partially overlapping in time with the data message reference signal, wherein the second set of data message reference signals is larger than the set of data message reference signals.

In a ninth aspect, alone or in combination with one or more of the first through eighth aspects, process 1000 includes transmitting, via a first portion of the first frequency subchannel, the sidelink control message, and transmitting, via a second portion of the first frequency subchannel during a same time resource as the sidelink control message, the data message reference signal in association with the sidelink control message at least partially overlapping in time with the data message reference signal, wherein the second set of data message reference signals and the first set of data message reference signals each have a same quantity of data message reference signals.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a transmitting UE, or a transmitting UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the transmitting UE.

In some aspects, the apparatus 1100 may be configured to perform one or more operations described herein in connection with FIGS. 6-7. Additionally, or alternatively, the apparatus 1100 may be configured to perform one or more processes described herein, such as process 800 of FIG. 8, process 900 of FIG. 9, process 10000 of FIG. 10, or a combination thereof. In some aspects, the apparatus 1100 and/or one or more components shown in FIG. 11 may include one or more components of the transmitting UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the transmitting UE described above in connection with FIG. 1, such as a radio, one or more RF chains, one or more transceivers, or one or more modems, each of which may in turn be coupled with one or more antennas of the transmitting UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the transmitting UE described above in connection with FIG. 1, such as a radio, one or more RF chains, one or more transceivers, or one or more modems, each of which may in turn be coupled with one or more antennas of the transmitting UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may obtain a sidelink control message for transmission that at least partially overlaps in time with a time domain location of a first set of one or more time domain locations for communicating a data message reference signal according to a first configuration. The transmission component 1104 may transmit, in accordance with a second configuration, the sidelink control message during the time domain location and a set of data message reference signals during a second set of one or more other time domain locations in accordance with obtaining the sidelink control message.

The transmission component 1104 may transmit the sidelink control message in association with transmitting the set of data message reference signals in accordance with the second configuration.

The transmission component 1104 may transmit, to a receiving UE, an indication that the sidelink control message was transmitted in accordance with the second configuration.

The reception component 1102 may receive a frequency resource allocation for transmitting the sidelink control message indicating a single frequency subchannel, wherein transmitting the sidelink control message in accordance with the second configuration is associated with the frequency resource allocation indicating a single frequency subchannel.

The reception component 1102 may obtain a sidelink control message for transmission via a first portion of a frequency allocation, wherein the sidelink control message at least partially overlaps in time with a time domain location for communicating a data message reference signal via a second portion of the frequency allocation according to a first configuration. The transmission component 1104 may transmit, in accordance with a second configuration and via the first portion of the frequency allocation, a first set of data message reference signals in accordance with obtaining the sidelink control message. The transmission component 1104 may transmit, according to the first configuration and via the second portion of the frequency allocation, a second set of data message reference signals including the data message reference signal.

The communication manager 1106 may communicate, with a receiving UE, capability signaling indicating that one or more of the transmitting UE or the receiving UE is capable of transmitting data message reference signals according to the first configuration and the second configuration.

The reception component 1102 may receive, from a receiving UE, a capability message indicating support for performing a first channel estimation procedure via the first portion of the frequency allocation and a second channel estimation procedure via the second portion of the frequency allocation.

The transmission component 1104 may transmit, via the first portion of the frequency allocation, the sidelink control message in association with transmitting the first set of data message reference signals.

The reception component 1102 may obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration. The transmission component 1104 may transmit, via the first frequency subchannel, a set of data message reference signals according to a second resource configuration of a set of resource configurations in a data message reference signal configuration.

The communication manager 1106 may select the second resource configuration in accordance with obtaining the sidelink control message.

The communication manager 1106 may calculate a size of a sidelink resource allocation, for transmitting the sidelink control message and the set of data message reference signals, using a quantity of time-frequency resources that correspond to a quantity of data message reference signal resources in the second resource configuration.

The transmission component 1104 may transmit the sidelink control message in association with transmitting the set of data message reference signals according to the second resource configuration.

The transmission component 1104 may transmit, to a receiving UE, an indication that the sidelink control message was transmitted.

The transmission component 1104 may transmit, via the second frequency subchannel and according to the second resource configuration, a second set of data message reference signals.

The communication manager 1106 may refrain from transmitting, via the first frequency subchannel, the data message reference signal in association with the sidelink control message at least partially overlapping in time with the data message reference signal, wherein the second set of data message reference signals is larger than the set of data message reference signals.

The transmission component 1104 may transmit, via a first portion of the first frequency subchannel, the sidelink control message.

The transmission component 1104 may transmit, via a second portion of the first frequency subchannel during a same time resource as the sidelink control message, the data message reference signal in association with the sidelink control message at least partially overlapping in time with the data message reference signal, wherein the second set of data message reference signals and the first set of data message reference signals each have a same quantity of data message reference signals.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a transmitting user equipment (UE), comprising: obtaining a sidelink control message for transmission that at least partially overlaps in time with a time domain location of a first set of one or more time domain locations for communicating a data message reference signal according to a first configuration; and transmitting, in accordance with a second configuration, the sidelink control message during the time domain location and a set of data message reference signals during a second set of one or more other time domain locations in accordance with obtaining the sidelink control message.

Aspect 2: The method of Aspect 1, wherein the first configuration indicates the first set of one or more time domain locations for transmitting the set of data message reference signals, and the second configuration indicates the second set of one or more time domain locations for transmitting the set of data message reference signals.

Aspect 3: The method of any of Aspects 1-2, comprising: transmitting the sidelink control message in association with transmitting the set of data message reference signals in accordance with the second configuration.

Aspect 4: The method of any of Aspects 1-3, comprising: transmitting, to a receiving UE, an indication that the sidelink control message was transmitted in accordance with the second configuration.

Aspect 5: The method of any of Aspects 1-4, wherein the first configuration includes a first set of one or more time domain locations, for communicating sidelink control messages, corresponding to a second set of time domain locations, of the second configuration, for communicating sidelink control messages.

Aspect 6: The method of any of Aspects 1-5, further comprising: receiving a frequency resource allocation for transmitting the sidelink control message indicating a single frequency subchannel, wherein transmitting the sidelink control message in accordance with the second configuration is associated with the frequency resource allocation indicating a single frequency subchannel.

Aspect 7: A method of wireless communication performed by a transmitting user equipment (UE), comprising: obtaining a sidelink control message for transmission via a first portion of a frequency allocation, wherein the sidelink control message at least partially overlaps in time with a time domain location for communicating a data message reference signal via a second portion of the frequency allocation according to a first configuration; transmitting, in accordance with a second configuration and via the first portion of the frequency allocation, a first set of data message reference signals in accordance with obtaining the sidelink control message; and transmitting, according to the first configuration and via the second portion of the frequency allocation, a second set of data message reference signals including the data message reference signal.

Aspect 8: The method of Aspect 7, The apparatus of Aspect 7 wherein transmitting in accordance with the second configuration is based on a capability for supporting the second configuration.

Aspect 9: The method of any of Aspects 7-8, comprising: communicating, with a receiving UE, capability signaling indicating that one or more of the transmitting UE or the receiving UE is capable of transmitting data message reference signals according to the first configuration and the second configuration.

Aspect 10: The method of any of Aspects 7-9, comprising: receiving, from a receiving UE, a capability message indicating support for performing a first channel estimation procedure via the first portion of the frequency allocation and a second channel estimation procedure via the second portion of the frequency allocation.

Aspect 11: The method of any of Aspects 7-10, wherein the second configuration is associated with communications including one or more sidelink control messages.

Aspect 12: The method of Aspect 11, wherein the second set of data message reference signals includes a quantity of data message reference signals that is equal to or greater than a quantity of data message reference signals included in the first set of data message reference signals.

Aspect 13: The method of any of Aspects 7-12, wherein the first set of data message reference signals is transmitted via a first set of time resources and the second set of data message reference signals is transmitted via a second set of time resources that at least partially overlaps with the first set of time resources.

Aspect 14: The method of any of Aspects 7-13, wherein the first portion of the frequency allocation includes a first frequency subchannel of a set of frequency subchannels and the second portion of the frequency allocation includes a second frequency subchannel of the set of frequency subchannels.

Aspect 15: The method of any of Aspects 7-14, wherein the first portion of the frequency allocation includes a portion of a first frequency subchannel of a set of frequency subchannels, and the second portion of the frequency allocation includes a second portion of the first frequency subchannel and a second frequency subchannel of the set of frequency subchannels.

Aspect 16: The method of any of Aspects 7-15, wherein the first configuration includes a first set of one or more time domain locations for the set of data message reference signals and the second configuration includes a second set of one or more time domain locations for the set of data message reference signals.

Aspect 17: The method of any of Aspects 7-16, comprising: transmitting, via the first portion of the frequency allocation, the sidelink control message in association with transmitting the first set of data message reference signals.

Aspect 18: A method of wireless communication performed by a transmitting user equipment (UE), comprising: obtaining a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration; and transmitting, via the first frequency subchannel, a set of data message reference signals according to a second resource configuration of a set of resource configurations in a data message reference signal configuration.

Aspect 19: The method of Aspect 18, wherein each resource configuration of the set of resource configurations is associated with a same quantity of time-frequency resources.

Aspect 20: The method of any of Aspects 18-19, comprising: selecting the second resource configuration in accordance with obtaining the sidelink control message.

Aspect 21: The method of any of Aspects 18-20, wherein the second resource configuration includes only a single set of resource configurations.

Aspect 22: The method of any of Aspects 18-21, comprising: calculating a size of a sidelink resource allocation, for transmitting the sidelink control message and the set of data message reference signals, using a quantity of time-frequency resources that correspond to a quantity of data message reference signal resources in the second resource configuration.

Aspect 23: The method of any of Aspects 18-22, comprising: transmitting the sidelink control message in association with transmitting the set of data message reference signals according to the second resource configuration.

Aspect 24: The method of any of Aspects 18-23, comprising: transmitting, to a receiving UE, an indication that the sidelink control message was transmitted.

Aspect 25: The method of any of Aspects 18-24, comprising: transmitting, via the second frequency subchannel and according to the second resource configuration, a second set of data message reference signals.

Aspect 26: The method of Aspect 25, comprising: refraining from transmitting, via the first frequency subchannel, the data message reference signal in association with the sidelink control message at least partially overlapping in time with the data message reference signal, wherein the second set of data message reference signals is larger than the set of data message reference signals.

Aspect 27: The method of Aspect 25, comprising: transmitting, via a first portion of the first frequency subchannel, the sidelink control message; and transmitting, via a second portion of the first frequency subchannel during a same time resource as the sidelink control message, the data message reference signal in association with the sidelink control message at least partially overlapping in time with the data message reference signal, wherein the second set of data message reference signals and the first set of data message reference signals each have a same quantity of data message reference signals.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a transmitting user equipment (UE), comprising:
one or more memories; and
one or more processors, coupled to the one or more memories, configured to cause the transmitting UE to:
obtain a sidelink control message for transmission that at least partially overlaps in time with a time domain location of a first set of one or more time domain locations for communicating a data message reference signal according to a first configuration; and
transmit, in accordance with a second configuration, the sidelink control message during the time domain location and a set of data message reference signals during a second set of one or more other time domain locations in accordance with obtaining the sidelink control message.

2. The apparatus of claim 1, wherein the first configuration indicates the first set of one or more time domain locations for transmitting the set of data message reference signals, and the second configuration indicates the second set of one or more time domain locations for transmitting the set of data message reference signals.

3. The apparatus of claim 1, wherein the one or more processors are further configured to cause the transmitting UE to:
transmit the sidelink control message in association with transmitting the set of data message reference signals in accordance with the second configuration.

4. The apparatus of claim 1, wherein the one or more processors are further configured to cause the transmitting UE to:
transmit, to a receiving UE, an indication that the sidelink control message was transmitted in accordance with the second configuration.

5. The apparatus of claim 1, wherein the first configuration includes a first set of one or more time domain locations, for communicating sidelink control messages, corresponding to a second set of time domain locations, of the second configuration, for communicating sidelink control messages.

6. The apparatus of claim 1, further comprising:
receiving a frequency resource allocation for transmitting the sidelink control message indicating a single frequency subchannel, wherein transmitting the sidelink control message in accordance with the second configuration is associated with the frequency resource allocation indicating a single frequency subchannel.

7. An apparatus for wireless communication at a transmitting user equipment (UE), comprising:
one or more memories; and
one or more processors, coupled to the one or more memories, configured to cause the transmitting UE to:
obtain a sidelink control message for transmission via a first portion of a frequency allocation, wherein the sidelink control message at least partially overlaps in time with a time domain location for communicating a data message reference signal via a second portion of the frequency allocation according to a first configuration;
transmit, in accordance with a second configuration and via the first portion of the frequency allocation, a first set of data message reference signals in accordance with obtaining the sidelink control message; and
transmit, according to the first configuration and via the second portion of the frequency allocation, a second set of data message reference signals including the data message reference signal.

8. The apparatus of claim 7 wherein transmitting in accordance with the second configuration is based on a capability for supporting the second configuration.

9. The apparatus of claim 7, wherein the one or more processors are further configured to cause the transmitting UE to:
communicate, with a receiving UE, capability signaling indicating that one or more of the transmitting UE or the receiving UE is capable of transmitting data message reference signals according to the first configuration and the second configuration.

10. The apparatus of claim 7, wherein the one or more processors are further configured to cause the transmitting UE to:
receive, from a receiving UE, a capability message indicating support for performing a first channel estimation procedure via the first portion of the frequency allocation and a second channel estimation procedure via the second portion of the frequency allocation.

11. The apparatus of claim 7, wherein the second configuration is associated with communications including one or more sidelink control messages.

12. The apparatus of claim 11, wherein the second set of data message reference signals includes a quantity of data message reference signals that is equal to or greater than a quantity of data message reference signals included in the first set of data message reference signals.

13. The apparatus of claim 7, wherein the first set of data message reference signals is transmitted via a first set of time resources and the second set of data message reference signals is transmitted via a second set of time resources that at least partially overlaps with the first set of time resources.

14. The apparatus of claim 7, wherein the first portion of the frequency allocation includes a first frequency subchannel of a set of frequency subchannels and the second portion of the frequency allocation includes a second frequency subchannel of the set of frequency subchannels.

15. The apparatus of claim 7, wherein the first portion of the frequency allocation includes a portion of a first frequency subchannel of a set of frequency subchannels, and the second portion of the frequency allocation includes a second portion of the first frequency subchannel and a second frequency subchannel of the set of frequency subchannels.

16. The apparatus of claim 7, wherein the first configuration includes a first set of one or more time domain locations for the set of data message reference signals and the second configuration includes a second set of one or more time domain locations for the set of data message reference signals.

17. The apparatus of claim 7, wherein the one or more processors are further configured to cause the transmitting UE to:
transmit, via the first portion of the frequency allocation, the sidelink control message in association with transmitting the first set of data message reference signals.

18. An apparatus for wireless communication at a transmitting user equipment (UE), comprising:
one or more memories; and
one or more processors, coupled to the one or more memories, configured to cause the transmitting UE to:
obtain a sidelink control message for transmission via a first frequency subchannel of a set of frequency subchannels, wherein the sidelink control message at least partially overlaps in time with a time domain location for communicating a data message reference signal via a second frequency subchannel of the set of frequency subchannels according to a first resource configuration; and
transmit, via the first frequency subchannel, a set of data message reference signals according to a second resource configuration of a set of resource configurations in a data message reference signal configuration.

19. The apparatus of claim 18, wherein each resource configuration of the set of resource configurations is associated with a same quantity of time-frequency resources.

20. The apparatus of claim 18, wherein the one or more processors are further configured to cause the transmitting UE to:
select the second resource configuration in accordance with obtaining the sidelink control message.
